(19) United States
(12) Patent Application Publication
(10) Pub. No.: US 2009/0042601 A1
(43) Pub. Date: Feb. 12, 2009

(54) LTE MEASUREMENT DEFINITIONS FOR INTER RADIO TECHNOLOGY MEASUREMENT WITH NON-3GPP RADIO ACCESS

(75) Inventors: Jin Wang, Central Islip, NY (US); Peter S. Wang, East Setauket, NY (US); Shankar Somasundaram, Deer Park, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/186,608

(22) Filed: Aug. 6, 2008

Related U.S. Application Data
(60) Provisional application No. 60/954,264, filed on Aug. 6, 2007.

(51) Int. Cl. H04M 1/00

(52) U.S. Cl. 455/553.1

(57) ABSTRACT

A method and apparatus for measurement in a wireless transmit receive unit (WTRU) including the WTRU operating in a first radio access technology (RAT), the WTRU receiving a list comprising a plurality of RATs, wherein each of the plurality of RATs is ranked according to a priority, and the WTRU measuring a second RAT based on the priority.

### CROSS REFERENCE TO RELATED APPLICATIONS

This application claims the benefit of U.S. provisional application No. 60,954,264, filed Aug. 6, 2007, which is incorporated by reference as if fully set forth.

### FIELD OF INVENTION

This application is related to wireless communications.

### BACKGROUND

The Third Generation Partnership Project (3GPP) has initiated the Long Term Evolution (LTE) program to bring new technology, new network architecture, new configuration and new applications and services to the wireless cellular networks in order to provide improved spectral efficiency and faster user experiences.

3GPP includes a number of standards for wireless networks across a number of frequency spectrums. However, not all wireless networks are compliant with 3GPP. With the variety of wireless networks currently in place, and with the soon to be delivered new systems, it is inevitable that a wireless transmit receive unit (WTRU), while mobile, will encounter any number of different radio access technologies (RATs). For example, an LTE-compliant WTRU may encounter a GSM network, CDMA2000 network or a WiMax network.

It is also inevitable that an LTE-compliant WTRU may need to handover to a non-LTE network in order to preserve seamless performance for an end user. The LTE-compliant WTRU may be required to take measurements over the non-LTE networks to support the handover process. It would be desirable to have a method and apparatus to help make the process faster, easier, more reliable and more robust.

### SUMMARY

A method and apparatus is disclosed for an LTE compliant WTRU to measure a non-LTE cell. This may include the WTRU measuring the non-LTE cells based on a priority that is assigned by an enhanced UMTS terrestrial radio access network (E-UTRAN). The WTRU may measure on a RAT by RAT basis. The WTRU may also receive measurement gap information from the E-UTRAN along with an assignment of which RAT to measure. The measurement assignment may be determined implicitly by both the WTRU and E-UTRAN based on the priority assignment. The WTRU may also measure multiple channels in a multi-channel frequency.

### BRIEF DESCRIPTION OF THE DRAWINGS

A more detailed understanding of the invention may be had from the following description, given by way of example and to be understood in conjunction with the accompanying drawings wherein:

FIG. 1 shows an example wireless communication system including a plurality of wireless transmit/receive units (WTRUs) and an e Node B; and

FIG. 2 is a functional block diagram of a WTRU and the base station of FIG. 1.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

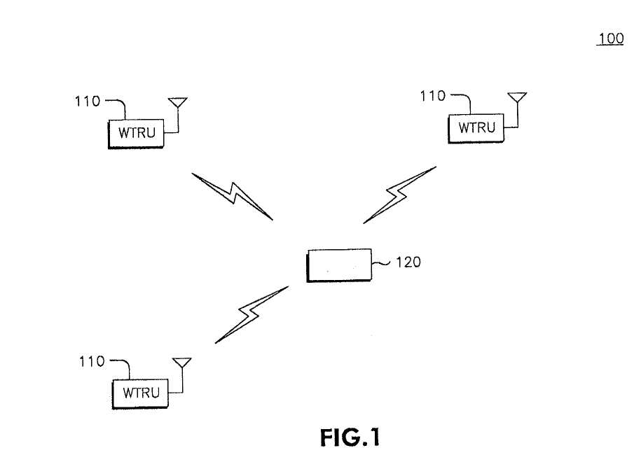

FIG. 1 shows a wireless communication system 100 including a plurality of WTRUs 110 and an eNB 120. As shown in FIG. 1, the WTRUs 110 are in communication with the eNB 120. Although three WTRUs 110 and one eNB 120 are shown in FIG. 1, it should be noted that any combination of wireless and wired devices may be included in the wireless communication system 100.

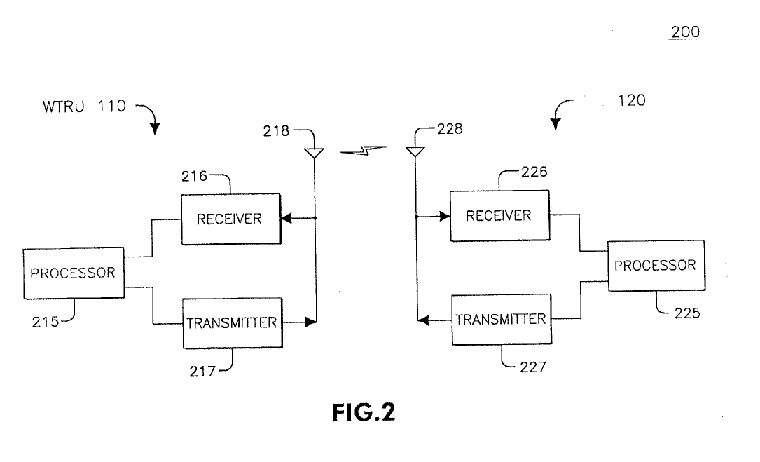

FIG. 2 is a functional block diagram 200 of a WTRU 110 and the eNB 120 of the wireless communication system 100 of FIG. 1. As shown in FIG. 1, the WTRU 110 is in communication with the base station 120 and both are configured to perform a method of measurement control and reporting.

In addition to the components that may be found in a typical WTRU, the WTRU 110 includes a processor 215, a receiver 216, a transmitter 217, and an antenna 218. The processor 215 is configured to perform measurement functions with the receiver 216, determine measurement procedures, and perform other procedures related to handover. The receiver 216 and the transmitter 217 are in communication with the processor 215. The antenna 218 is in communication with both the receiver 216 and the transmitter 217 to facilitate the transmission and reception of wireless data.

In addition to the components that may be found in a typical base station, the base station 220 includes a processor 225, a receiver 226, a transmitter 227, and an antenna 228. The processor 225 is configured to determine measurement procedures, perform measurement procedures and read and transmit messages regarding measurement and handover. The receiver 226 and the transmitter 227 are in communication with the processor 225. The antenna 228 is in communication with both the receiver 226 and the transmitter 227 to facilitate the transmission and reception of wireless data.

A WTRU may function in different states. When a WTRU is in an IDLE state, circumstances may require that the WTRU begin measurement routines for cell reselection. For example, if the signal strength of a serving cell falls below a threshold, as measured by received signal strength indicator (RSSI), or by signal and interference to noise ratio (SINR), in IDLE state, the WTRU may begin to look for a cell for handover.

An LTE compliant WTRU, functioning within an LTE compliant cell, may begin measuring LTE cells before measuring non-LTE cells. The WTRU can measure LTE cells in the same frequency without the use of measurement gaps, so reselecting to an LTE compliant cell requires less overhead and signaling.

However, an LTE compliant cell may not always be available for handover. A non-LTE cell, that is, a cell that uses non-LTE radio access technology (RAT), such as GSM or 3GPP2/WiMax, for example, may be the only available cell for reselection and handover. In order to determine which cells will be measured first by the WTRU, the WTRU may refer to a list that is supplied by the network that ranks the non-LTE frequency bands or cells by priority. The network may publish the priority list, which may be known as an inter-RAT-priority-order-list, for the WTRUs to follow. This inter-RAT-priority-order-list can be referenced by the WTRU and includes an assigned priority level to each RAT. This list may change as the WTRU travels between delineated geographical areas. Along with priority rankings, the list entry may include load factors of each RAT frequency. The load factor may be used by the WTRU to determine how many WTRUs using a particular RAT are active. The load factor may also be used by the WTRU to determine how many WTRUs are active in a particular cell and how many requests are generated by the WTRUs within a particular RAT or cell. The WTRU may then select the cell using the RAT with the highest priority first, and then based on the least loaded cell.

The WTRU may determine which cells to measure by referring to a neighbor cell list (NCL). The NCL may be broadcast to all the WTRUs in a particular cell. The NCL may contain information regarding the ability to handover to a particular cell, the ability to select/reselect a particular cell, and the RAT used in particular cell. If a WTRU receives an NCL, it may use the list to select which neighbor cells it may measure for cell reselection or handover.

If an NCL is not broadcast, an E-NodeB (eNB) may broadcast an RRC message that includes the inter-RAT-priority-order-list. The list may specify the order in which neighboring non-LTE RATs, and their cells, may be measured. The list may be used alone or as a supplement to the NCL, if all LTE cells and higher priority inter-RAT cells are determined to be not reselectable due to, for example, weak radio measurements or network/tracking area access restrictions.

An LTE-compliant WTRU functioning in an LTE cell may have no LTE cells available for handover. In that case, the LTE-compliant WTRU may be required to perform measurement procedures on a CDMA2000 cell or a WiMAX cell, for example. If an LTE-compliant WTRU is required to measure a cell or a WiMax cell, the WTRU may require an assignment of measurement gaps for performing handover measurements in the proper frequency bands. Measurement gaps are assigned time intervals when the WTRU is free to perform measurement procedures on different RAT transmissions. These gaps are assigned by the LTE compliant serving cell and are gaps in transmission during which no data is sent between the serving cell and the WTRU. This is to prevent data loss when the WTRU radio is tuned to a frequency and waveform of a different RAT for measurements.

The WTRU may determine which CDMA2000 or WiMax cell to measure based on the NCL or the inter-RAT-priority-list. An E-UTRAN may detect CDMA2000 cells or WiMAX cells and compile a list that assigns a measurement priority to each RAT containing the cell. The E-UTRAN may also be informed by the core network regarding CDMA2000 and WiMAX and cells. The E-UTRAN may place a priority on each RAT and broadcast the list, through an eNB, to the WTRU. An LTE-compliant WTRU may receive the list from an eNB via the LTE system information broadcast, read the list, and store the list so that inter-RAT measurement may be performed in an ordered fashion.

Measurements may be conducted one RAT at a time according to the RAT priority list. The WTRU may tune to a particular frequency and waveform, and stay tuned to that frequency and waveform until all the detectable cells of the particular RAT are measured. This allows individual LTE-compliant WTRUs to concentrate the measurement process on a particular inter-RAT frequency band before measuring another inter-RAT frequency band that has a lower priority. This may prevent the WTRU from jumping back and forth between RATs and save the WTRU processing and battery power. The WTRU may continue to measure neighbor cells based on the RAT used until a cell that is suitable for handover is discovered, or until all the cells measured by the WTRU are deemed unsuitable for handover.

The WTRU may determine if a cell handover is possible in a particular RAT by comparing the measured results to a predetermined threshold. Furthermore, the WTRU may send a measurement report to the eNB that includes the comparison to the threshold along with other measurement data including measured signal strength, the SNR, the measured RAT and the measured cell identities. After sending the report, the WTRU may measure the next RAT. This may include measuring a single cell or all the cells using the new RAT.

Additionally, an eNB may use an offset to control the measured result. The offset may be set by the eNB, or by the E-UTRAN, and may be used to determine which RAT, and therefore which cell, to use for handover. The WTRU may measure all configured or detectable RATs and cells, and report the measurement results, with the offset adjustment, to the eNB, and ultimately to the E-UTRAN. The offset value may be a strength value of a signal measurement, and may be in units of db or dbm. The network may configure and assign different measurement thresholds, or offsets, to different RATs, and use the offsets to control which RATs are more likely to be selected by the WTRU. For example, if the network determines that a WTRU should reselect or handover to more GSM cells than to WiMax cells, the network may configure a higher measurement threshold by adding an offset for WiMax so that it would be more difficult for the WTRU to meet WiMax measurement standards for reselection and handover. Furthermore, the network may configure a lower measurement threshold, by subtracting an offset, for GSM cells, making it easier for a WTRU to meet measurement standards for GSM reselection and handover.

An LTE-compliant WTRU may be assigned by the e-UTRAN or an eNB to begin measuring neighbor cells on a new RAT on the priority list when the eNB is triggered by a measurement event. For example, a WTRU may report to the eNB that certain measured metrics in the cell of a particular RAT being used by the WTRU has fallen below a threshold. This may trigger the eNB/E-UTRAN to assign measurement gaps to the WTRU with respect to a new RAT such as CDMA2000 or WiMax so that the WTRU may start measurement procedures on neighboring cells of the new RAT on the RAT priority list, as set forth above.

The LTE inter-RAT measurement event may be referred to as, for example, Inter_RAT_new_event_{—}1. The Inter_RAT_new_event_{—}1 may be defined as occurring when measurement results from all measurable LTE cells, including the serving cell, all intra-frequency cells and all inter-frequency cells, are below a certain threshold and the listed inter-RAT frequency band qualities are below a particular frequency band threshold.

As part of the measurement event, categories of RATs may be reported based on a single bit in a bitmap. Some examples of RAT categories may be, for example, GERAN900, GERAN1800, UTRAN-1900, UTRAN-1800, UTRAN-900, CDMA2000, or WiMax. Each bitmap may include one (1) bit for each category. If the bit is set to a one “1”, a measurement report for the RAT may be included in the event report. As a result of the event report, the E-UTRAN may assign another RAT category next on the list for the WTRU to measure. For example, the measurement report may include a “1” in relation to GERAN1800, meaning that the report includes measurement of GERAN1800 cells. It none of the measurements meet the standard for reselection and/or handover criteria, the E-UTRAN may assign a new RAT, for example, UTRAN-1800, to the WTRU for measurement.

Rather than use a relatively large number of bits to define the inter-RAT category in the event report, the category may be reported as the inter-RAT measurement and handover priority order number that was previously received by the WTRU in a system information broadcast. The service provider may choose the RAT priority-order and assign the WTRU to process inter-RAT measurements consistent with the priority-order. When the reported priority-order number is included in the event report, inter-RAT measurement of the RAT with the next priority level can be assigned to the WTRU.

For example, an inter-RAT UTRAN may be priority 1, inter-RAT GERAN priority 2 and inter-RAT WiMAX priority 3. The WTRU may report “priority 2”, which is GERAN in the event report. The report may trigger the network to assign measurement of the RAT with the next priority, for example, “priority 3” or WiMAX. The assignment of the RAT would be accompanied by the proper assignment of measurement gap.

When a LTE-compliant WTRU measures a WiMAX or WiFi frequency band, the WTRU must be configured to measure multiple channels within each frequency band. For example, there are up to 11 frequency channels in a WiFi system that can be used by a WTRU after handover. The WTRU may be able to scan each channel within the frequency band to determine the best channel to use at the measurement.

A WTRU may report a change of the best channel within a WiMax or WiFi cell due to measured metrics. Another inter-RAT measurement event (inter-RAT-measurement-event-2) may be defined and used to report the change of the best channel in a non-LTE RAT that has multiple channels, such as WiFi or WiMAX. Event reporting criteria may be based on the measured channel received signal strength indication (RSSI), the measured channel block error rate (BLER) or a composite value of both. The WiMAX/WiFi channel evaluation formulas may be defined as:

a. For RSSI only, RSSI Evaluation=W×RSSI+(1−W)×RSSI (EQUATION 1);

b. For BLER only, BLER Evaluation=W×BLER+(1−W)×BLER (EQUATION 2); and

c. For RSSI and BLER composite value, Composite_value=W×RSSI+(1−W)×BLER_converted_dBm (EQUATION 3).

For each equation, W is a network assigned weight value (0<=W<=1). W can be different for different value evaluations. The W (weight value) can be different depending on which of the above equations is used.

When performing an inter-RAT measurement in a WiMAX or Wi-Fi network, an LTE-compliant WTRU may evaluate each of the WiMAX/Wi-Fi channels, unless the channel is barred from LTE usage. The WTRU in LTE could be configured with a set of channels on which it should not scan on the WiMAX or Wi-FI network. An NCL may include which cells the WTRU should not scan for their individual RSSI and/or BLER. The WTRU may report the event to the eNB so that the E-UTRAN may evaluate the best channel.

In addition to the parameters for the other RATs, such as number of packets, an offset specific to the RAT, or a scaling value for a particular RAT, may be defined.

An LTE-compliant WTRU functioning in a non-LTE cell may use a timer to activate the cell reselection process. The timer may be set for a time period longer than 1 second.

The priority value associated with each of the RATs may be calculated by the equation P_{RAT,n}=Qₘₑₐₛ₋ₙ×(PRAT×1/N +Q_{offset-RAT}+other-timed-factors (Equation 4), where PRAT is the priority value assigned to the RAT. The greater the P_{RAT} value, the higher the priority of the RAT. N is the normalization denominator for scaling the PRAT in the formula. If the P_{RAT} value is smaller when the RAT priority value is higher, the formula can be changed to R_{RAT,n}=Qₘₑₐₛ₋ₙ×(1/P_{RAT}×N)+Q_{offset-RAT}+other-timed-factors (Equation 5).

The Treselection values for an LTE-compliant WTRU reselecting into a non-LTE cell may be increased over prior standards.

The Q_{offset} and/or Q_{Hyst} values used by a LTE-compliant WTRU when reselecting a non-LTE cell can be determined based on whether the WTRU has subscribed to a non-LTE RAT. When the WTRU subscribes to the RAT, the offset bias can be favorable. Likewise, the offset bias may be unfavorable if the WTRU has not subscribed to the RAT.

For WiMAX or Wi-Fi, RSSI, BLER and a number of discard packets may be used as a measurement value. RSSI is an indication of the total wideband received power from the WiMAX frequency band. BLER on a maximum strength channel indicates the channel quality of the WiMAX access (a minimum number of data blocks/packets is required/configured for the BLER measurement). The number of discarded packets is an indication of the channel conditions that a WTRU may experience and may be used as one of the metrics of the quality of measure of the channel.

Alternatively, rather than define a set of measurement parameters for each RAT, the eNB may define one common set of parameters. The common set of parameters may be inclusive and may be transmitted to a WTRU irrespective of whether the LTE-compliant WTRU is planning to measure a non-LTE cell. The WTRU may select the appropriate list of parameters that it requires for a particular RAT. The WTRU may store the parameters to measure and report. Alternatively, the eNB may explicitly signal the parameters the WTRU needs for each particular RAT.

If the WTRU is measuring across many RATs where the parameters for the RATs are different, rather than reporting a set of measurements in a measurement report, the WTRU may report a vector of measurements, for example, signal strength, BLER, number of packets received, and the like. The E-UTRAN may examine all the reports and use the measurement vectors to select a cell. The selected call may be transmitted back to the WTRU. The WTRU may conduct measurements as appropriate and report back to the E-UTRAN. The E-UTRAN may perform the comparisons.

Alternatively, the WTRU may use the vector of measurements to rank the strongest cell and select the best non-LTE RAT. For example, a weighted sum of all the measurements could be taken. By way of another example, valid measurements of one network may be translated into an absolute rank such that the WTRU may determine the non-LTE RAT it may select to.

For example, if the WTRU is doing a comparison with a GSM network, where it measures RSSI, versus a non-LTE network, where it measures BLER as its primary parameter, the WTRU may perform the ranking by putting the comparisons on an even scale. The WTRU may convert the BLER measured to corresponding, existing value of RSSI. The WTRU may use a mapping table, as shown below in Table 1.

TABLE 1

| BLER | RSSI |
|---|---|
| Upto 1% | −45 dB |
| 1-3% | −55 dB |
| 3-7% | −70 dB |
| >7% | −90 dB |

The mapping table of TABLE 1 shows BLER values and equivalent RSSI values. For example, a BLER measurement between 3 and 7 percent maps to an RSSI value of −70 dB. The WTRU can convert the BLER to RSSI values for comparison with a GSM network, for example. The WTRU may determine the strongest cell and appropriately select to it.

Although the features and elements are described in the embodiments in particular combinations, each feature or element can be used alone without the other features and elements or in various combinations with or without other features and elements of the present invention. The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method of measurement in a wireless transmit receive unit (WTRU), the method comprising:
the WTRU operating in a first radio access technology (RAT);
the WTRU receiving a list comprising a plurality of RATs, wherein each of the plurality of RATs is ranked according to a priority; and
the WTRU measuring a second RAT based on the priority.

2. The method as in claim 1 further comprising the WTRU transmitting a measurement report to an e Node B.

3. The method as in claim 2 wherein the measurement report includes a RAT identifier and the RAT identifier corresponds to the priority.

4. The method as claim 1 further comprising:
the WTRU measuring a plurality of cells operating with the second RAT;
the WTRU reporting the measurement; and
the WTRU measuring a plurality of cells operating with a third RAT.

5. The method as in claim 4 further comprising the WTRU receiving measurement instructions regarding the third RAT based on the priority of the third RAT.

6. The method as in claim 5 wherein the measurement instructions include measurement gap assignment.

7. The method as in claim 1 wherein the list further comprises a plurality of load factors.

8. The method as in claim 1 further comprising the WTRU receiving the list in a radio resource control (RRC) message.

9. The method as in claim 1 further comprising the WTRU receiving the list in a system information broadcast.

10. The method as in claim 1 further comprising the WTRU receiving measurement instructions based on a measurement event trigger.

11. The method as in claim 10 further wherein the measurement event trigger comprises a bitmap that is indicative of a category of RAT.

12. The method as in claim 1 further comprising the WTRU normalizing a received signal strength indication (RSSI) measurement in the first RAT to a block error rate (BLER) measurement in the second RAT.

13. A method of measurement in a wireless transmit receive unit (WTRU), the method comprising:
the WTRU operating in a first channel of a multi-channel frequency band;
the WTRU measuring the first channel;
the WTRU reporting a change of best channel based on the measuring of the first channel;
the WTRU receiving instructions to measure a second channel of the multi-channel frequency band; and
the WTRU measuring the second channel and transmitting a measurement report.

14. The method as in claim 13 further comprising the WTRU determining the best channel based on a received signal strength indicator (RSSI), a block error rate (BLER) or a composite of RSSI and BLER.

15. A wireless transmit receive unit (WTRU) comprising a processor, wherein the processor is configured to:
operate in a first radio access technology (RAT);
receive a list comprising a plurality of RATs, wherein each of the plurality of RATs is ranked according to a priority; and
measure a second RAT based on the priority.

16. The WTRU as in claim 15 wherein the processor is further configured to transmit a measurement report to an e Node B.

17. The WTRU as in claim 16 wherein the measurement report includes a RAT identifier and the RAT identifier corresponds to the priority.

18. The WTRU as in claim 15 wherein the processor is further configured to:
measure a plurality of cells operating with the second RAT;
report the measurement; and
measure a plurality of cells operating with a third RAT.

19. The WTRU as in claim 18 wherein the processor is further configured to receive measurement instructions regarding the third RAT based on the priority of the third RAT.

20. The WTRU as in claim 19 wherein the measurement instructions include measurement gap assignment.

21. The WTRU as in claim 15 wherein the list further comprises a plurality of load factors.

22. A wireless transmit receive unit (WTRU) comprising a processor wherein the processor is configured to
operate in a first channel of a multi-channel frequency band;
measure the first channel;
report a change of best channel based on the measuring of the first channel;
receive instructions to measure a second channel of the multi-channel frequency band; and
measure the second channel and transmitting a measurement report.
